(19) United States
(12) Patent Application Publication
(10) Pub. No.: US 2010/0005725 A1
(43) Pub. Date: Jan. 14, 2010

(54) Window regulator and attaching method of lift arm and equalizer arm of window regulator

(75) Inventors: Kousuke Nagai, Kanagawa (JP); Osamu Ando, Kanagawa (JP); Kouhei Jiuchi, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: SHIROKI CORPORATION

(21) Appl. No.: 12/285,360

(22) Filed: Oct. 2, 2008

(30) Foreign Application Priority Data
Jul. 8, 2008 (JP) 2008-177515

(51) Int. Cl. E05D 15/16; E06B 3/36

(52) U.S. Cl. 49/407; 49/506

(57) ABSTRACT

A window regulator has a separation inhibiting portion that inhibits separation of first and second arm portions forming an equalizer arm, which is formed of a hole formed to penetrate through the second arm portion and a rising wall portion (convex portion) formed in the first arm portion, a part of which protruding to an outside from the hole of the second arm portion when inserted into a hole of the lift arm and the hole of the second arm portion is caulked so as to come into contact with a rim of the hole of the second arm portion, and a rotation inhibiting portion that inhibits relative rotations of the first and second arm portions, which is formed of a hole (concave portion) formed in the first arm portion and a notch portion caulked so as to engage with the hole of the second arm portion.

### BACKGROUND OF THE INVENTION

1. Field of the Invention

The present invention relates to a window regulator that includes: a lift arm having a hole formed to penetrate through an intermediate portion and provided in a rotatable manner; a lift arm bracket attached to a windowpane and provided with a guide extending in a direction crossing an opening and closing direction of the windowpane and configured to engage with a tip end portion of the lift arm by the guide; an equalizer arm formed of a first arm portion and a second arm portion, an intermediate portion of which is pivotally attached to the intermediate portion of the lift arm in a rotatable manner while crossing the lift arm in a shape of a letter X and a tip end portion of which engages with the lift arm bracket when the first arm portion and the second arm portion are attached to each other via the hole of the lift arm; and an equalizer arm bracket provided with a guide parallel to the guide of the lift arm bracket and configured to guide a base end portion of the equalizer arm by the guide, and is configured to open and close the windowpane by rotating the lift arm. The invention also relates to an attaching method of the lift arm and the equalizer arm of the window regulator.

2. Background Art

Firstly, an X-arm window regulator will be described using FIG. 12.

In the drawing, a base plate 1 is attached to an unillustrated door panel (inner panel). A driven gear 3 is attached to the base plate 1 in a rotatable manner with a pin 2. The pin 2 is positioned at the center of an addendum circle of the driven gear 3.

The window regulator shown in FIG. 12 is a power-driven window regulator. Accordingly, a drive motor 4 provided integrally with a reduction gearbox is attached to the base plate 1. Although it is not shown in FIG. 12, a pinion is provided to the rotation shaft 4a, which is an output shaft of the gearbox. A teeth portion 3a of the driven gear 3 is meshed with the pinion. Hence, when the motor 4 rotates and the rotation shaft 4a is driven in a clockwise direction in FIG. 12, the driven gear 3 starts to rotate in a counterclockwise direction. Conversely, when the rotation shaft 4a is driven in a counterclockwise direction, the driven gear 3 rotates in a clockwise direction.

A lift arm 5 is attached to the driven gear 3 so as to point toward the radial direction of the addendum circle.

A lift arm bracket 6 is attached to the lower portion of an unillustrated windowpane. The cross section of the lift arm bracket 6 is formed substantially in the shape of a letter C. Further, the lift arm bracket 6 is provided with a slit-like guide 6a extending in a direction crossing an opening and closing direction M of the windowpane. A slider 7 movable along the guide 6a is engaged with the lift arm bracket 6. Further, the slider 7 is attached to the tip end portion of the lift arm 5 with a pin 8 in a rotatable manner.

The intermediate portion of an equalizer arm 10 is pivotally attached to the intermediate portion of the lift arm 5 in a rotatable manner while crossing the lift arm 5 in the shape of a letter X. To be more specific, the equalizer arm 10 is formed by integrally attaching a first arm portion 11 and a second arm portion 12 that are separately molded. In other words, as is shown in FIG. 11, which is a cross section taken on line A-A of FIG. 12, a cylindrical portion 114 of the first arm portion 11 fit into a hole 51c of the lift arm 5 in a rotatable manner and a cylindrical portion 124 of the second arm portion 12 disposed oppositely to the first arm 11 with the lift arm 5 in between are attached to each other by means of projection welding in a state where the end faces (bottom portions) of these portions press against each other. This configuration allows the first arm portion 11 and the second arm portion 12 to rotate integrally on the front and back of the lift arm 5.

Referring to FIG. 12 again, an equalizer arm bracket 13 is attached to the unillustrated door panel (inner panel). The cross section of the equalizer arm bracket 13 is formed substantially in the shape of a letter C. Further, the equalizer arm bracket 13 is provided with a guide 13a parallel to the guide 6a of the lift arm bracket 6. A slider 14 movable along the guide 13a is fit into the equalizer arm bracket 13. The slider 14 is attached to the base end portion (first arm portion 11) of the equalizer arm 10 with a pin 15 in a rotatable manner.

Meanwhile, a slider 16 is attached to the tip end portion (second arm portion 12) of the equalizer arm 10 with a pin 17 in a rotatable manner. The slider 16 is engaged with the guide 6a of the lift arm bracket 6 in a movable manner along the guide 6a.

An operation of the X-arm window regulator configured as above will now be described.

FIG. 12 shows a state where the windowpane is closed. The lift arm 5 is therefore fully rotated in a counterclockwise direction until the windowpane abuts on the window frame. In order to lower the windowpane from this state, the rotation shaft 4a is driven in a counterclockwise direction in FIG. 11 by the motor 4 so that the lift arm 5 rotates in a clockwise direction. When driven in this manner, the equalizer arm 10 rotates in a counterclockwise direction in association with rotations of the lift arm 5. The slider 7 and the slider 16 then come down while moving in the guiding direction of the guide 6a. The lift arm bracket 6 thus comes down and so does the windowpane. In order to raise the windowpane later, the rotation shaft 4a is driven in a clockwise direction by the motor 4.

JP-A-2001-219278 (FIG. 4 and FIG. 5) is an example of the background art.

In the X-arm window regulator configured as above, the first arm portion 11 and the second arm portion 12 of the equalizer arm 10 are attached to each other by means of projection welding. Accordingly, poor welding can occur for the reasons, such as a variance of projection shape, wearing of the electrodes, entrance of foreign matter into weld nugget (melted and then solidified materials at the welded portion).

Meanwhile, the welded portion is formed where the end face (bottom surface) of the cylindrical portion 114 of the first arm portion 11 and the end face (bottom surface) of the cylindrical portion 124 of the second arm portion 12 press against each other. It is therefore impossible to visually confirm the quality at the welded portion, and the quality of attachment of the first arm portion 11 and the second arm portion 12 cannot be confirmed unless the welded portion is destructed.

### SUMMARY OF THE INVENTION

The invention was devised in view of the problems discussed above and has an object to provide a window regulator that enables visual confirmation on the quality of attachment of a first arm portion and a second arm portion and an attaching method of a lift arm and an equalizer arm of the window regulator.

More specifically, according to a first aspect of the invention, a window regulator includes: a lift arm having a hole formed to penetrate through an intermediate portion and provided in a rotatable manner; a lift arm bracket attached to a windowpane and provided with a guide extending in a direction crossing an opening and closing direction of the windowpane and configured to engage with a tip end portion of the lift arm by the guide; an equalizer arm formed of a first arm portion and a second arm portion, an intermediate portion of which is pivotally attached to the intermediate portion of the lift arm in a rotatable manner while crossing the lift arm in a shape of a letter X and a tip end portion of which engages with the lift arm bracket when the first arm portion and the second arm portion are attached to each other via the hole of the lift arm; and an equalizer arm bracket provided with a guide parallel to the guide of the lift arm bracket and configured to guide a base end portion of the equalizer arm by the guide. The window regulator is configured in such a manner that: the windowpane is opened and closed by rotating the lift arm; separation of the first arm portion and the second arm portion is inhibited by a separation inhibiting portion formed of a hole formed to penetrate through the second arm portion and a convex portion formed in the first arm portion, a part of which protruding to an outside from the hole of the second arm portion when inserted into the hole of the lift arm and the hole of the second arm portion is caulked so as to come into contact with a rim of the hole of the second arm portion; and a relative rotation of the first arm portion and the second arm portion is inhibited by a rotation inhibiting portion formed of a concave portion formed in one of the first arm portion and the second arm portion and an engaging portion formed in the other arm portion to engage with the concave portion.

According to a second aspect of the invention, in the window regulator of the first aspect of the invention, the engaging portion forming the rotation inhibiting portion is a notch portion that is cut and bent so as to engage with the concave portion.

According to a third aspect of the invention, in the window regulator of the first aspect of the invention, the engaging portion forming the rotation inhibiting portion is a convex portion that is pushed out so as to engage with the concave portion.

According to a fourth aspect of the invention, in the window regulator of the first aspect of the invention, a caulking direction of the convex portion forming the separation inhibiting portion and a forming direction of the engaging portion forming the rotation inhibiting portion are in a same direction.

According to a fifth embodiment of the invention, in the window regulator of the second aspect of the invention, the notch portion forming the rotation inhibiting portion has a radial notch edge in a direction substantially along a radial direction of a rotational center axis of the lift arm and the equalizer arm and a root portion crossing the radial direction of the rotational center axis of the lift arm and the equalizer arm and connected to the other arm portion, and the root portion is present at an end of the radial notch edge on a side of the rotational center axis of the lift arm and the equalizer arm.

According to a sixth aspect of the invention, in the window regulator of the first aspect of the invention, the concave portion forming the rotation inhibiting portion is a rectangular hole in which an interval between two sides substantially along a radial direction of a rotational center axis of the lift arm and the equalizer arm increases gradually from the rotational center axis toward the radial direction, and the engaging portion forming the rotation inhibiting portion is a notch portion cut and bent so as to engage with the rectangular hole, which is of a rectangular shape in which an interval between two sides substantially along the radial direction of the rotational center axis of the lift arm and the equalizer arm increases gradually from the rotational center axis toward the radial direction.

According to a seventh aspect of the invention, in the window regulator of the first aspect of the invention, the concave portion forming the rotation inhibiting portion is a hole developed when the notch portion is formed by cutting and bending, the engaging portion forming the rotation inhibiting portion is a notch portion formed by cutting and bending so as to engage with the hole, and the notch portion formed as the concave portion and the notch portion formed as the engaging portion are bent in a same direction.

According to an eighth aspect of the invention, an attaching method of a lift arm and an equalizer arm of a widow regulator that is formed of: a lift arm having a hole formed to penetrate through an intermediate portion and provided in a rotatable manner; a lift arm bracket attached to a windowpane and provided with a guide extending in a direction crossing an opening and closing direction of the windowpane and configured to engage with a tip end portion of the lift arm by the guide; an equalizer arm formed of a first arm portion and a second arm portion, an intermediate portion of which is pivotally attached to the intermediate portion of the lift arm in a rotatable manner while crossing the lift arm in a shape of a letter X and a tip end portion of which engages with the lift arm bracket when the first arm portion and the second arm portion are attached to each other via the hole of the lift arm; and an equalizer arm bracket provided with a guide parallel to the guide of the lift arm bracket and configured to guide a base end portion of the equalizer arm by the guide, and configured to open and close the windowpane by rotating the lift arm, includes: a first step of forming a hole to penetrate through the second arm portion and forming a convex portion in the first arm portion so that a part of the convex portion of the first arm portion protruding to an outside from the hole of the second arm portion when inserted into the hole of the lift arm and the hole of the second arm is caulked so as to come into contact with a rim of the hole of the second arm portion; and a second step of forming a concave portion in one of the first arm portion and the second arm portion and forming an engaging portion to engage with the concave portion in the other arm portion.

According to a ninth aspect of the invention, in the attaching method of the eighth aspect of the invention, the engaging portion formed in the second step is a notch portion that is cut and bent so as to engage with the concave portion.

According to a tenth aspect of the invention, in the attaching method of the eighth aspect of the invention, the engaging portion formed in the second step is a convex portion that is pushed out so as to engage with the concave portion.

According to an eleventh aspect of the invention, in the attaching method of the eighth aspect of the invention, a caulking direction in the first step and a forming direction of the engaging portion in the second step are in a same direction.

According to a twelfth aspect of the invention, in the attaching method of the ninth aspect of the invention, the notch portion formed in the second step has a radial notch edge in a direction substantially along a radial direction of a rotational center axis of the lift arm and the equalizer arm and a root portion crossing the radial direction of the rotational center axis of the lift arm and the equalizer arm and connected to the other arm portion, and the root portion is present at an end of the radial notch edge on a side of the rotational center axis of the lift arm and the equalizer arm.

According to a thirteenth aspect of the invention, in the attaching method of the eighth aspect of the invention, the concave portion formed in the second step is a rectangular hole in which an interval between two sides substantially along a radial direction of a rotational center axis of the lift arm and the equalizer arm increases gradually from the rotational center axis toward the radial direction, and the engaging portion formed in the second step is a notch portion cut and bent so as to engage with the rectangular hole, which is of a rectangular shape in which an interval between two sides substantially along the radial direction of the rotational center axis of the lift arm and the equalizer arm increases -gradually from the rotational center axis toward the radial direction.

According to a fourteenth aspect of the invention, in the attaching method of the eighth aspect of the invention, the concave portion formed in the second step is a hole developed when the notch portion is formed by cutting and bending, the engaging portion formed in the second step is a notch portion formed by cutting and bending so as to engage with the hole, and the notch portion formed as the concave portion and the notch portion formed as the engaging portion are bent in a same direction.

According to the first through fourteenth aspects of the invention, the caulked portions, that is, the convex portion of the first arm portion and the engaging portion in one of the first arm portion and the second arm portion, are exposed to the outside. It thus becomes possible to visually confirm the quality of attachment of the first arm portion-and the second arm portion.

According to the second and ninth aspects of the invention, the engagement with the concave portion is facilitated regardless of the size of the concave portion.

According to the third and tenth aspects of the invention, a wider portion abuts on the concave portion. It thus becomes possible to regulate relative rotations of the first arm portion and the second arm portion more strictly.

According to the fourth and eleventh aspects of the invention, the caulking direction of the convex portion forming the separation inhibiting portion (formed in the first step) and the forming direction of the engaging portion forming the rotation inhibiting portion (formed in the second step) are in the same direction. Caulking can be thus applied by a set of a punch and a die and attachment of the lift arm and the equalizer arm can be completed in a single step.

According to the fifth and twelfth aspects of the invention, the notch portion forming the rotation inhibiting portion (formed in the second step) has the radial notch edge in a direction substantially along the radial direction of the rotational center axis of the lift arm and the equalizer arm and the root portion crossing the radial direction of the rotational center axis of the lift arm and the equalizer arm and connected to the other arm portion. The root portion is present at an end of the radial notch edge on the side of the rotational center axis of the lift arm and the equalizer arm. Hence, in comparison with a case where the root portion is present at an end of the radial notch edge on the opposite side of the rotational center axis of the lift arm and the equalizer arm, when a force such that induces rotational rotations of the first arm portion and the second arm portion is applied, relative rotations of the first arm portion and the second arm portion can be regulated more strictly, because the abutting portion of the notch portion and the concave portion is at a position farther from the center of the relative rotations of the first arm portion and the second arm portion. Also, a loading direction when the notch portion is caulked is a direction in which the equalizer arm moves away from the peripheral surface of the hole of the lift arm and it is also a direction in which the convex portion of the first arm portion and the peripheral surface of the hole of the second arm portion come close to each other. Rotations of the lift arm and the equalizer arm can be thus maintained smoothly.

According to the sixth and thirteenth aspects of the invention, the concave portion forming the rotation inhibiting portion (formed in the second step) is a rectangular hole in which the interval between the two side substantially along the radial direction of the rotational center axis of the lift arm and the equalizer arm increases gradually from the rotational center axis toward the radial direction. Also, the engaging portion forming the rotation inhibiting portion (formed in the second step) is a notch portion cut and bent so as to engage with the rectangular hole, which is of a rectangular shape in which the interval between the two sides substantially along the radial direction of the rotational center axis of the lift arm and the equalizer arm increases gradually from the rotational center axis toward the radial direction. Hence, not only can relative rotations of the first arm portion and the second arm portion be inhibited, but also separation of the first arm portion and the second arm portion can be inhibited.

According to the seventh and fourteenth aspects of the invention, the concave portion forming the rotation inhibiting portion (formed in the second step) is a hole developed when the notch portion is formed by cutting and bending, and the engaging portion forming the rotation inhibiting portion (formed in the second step) is a notch portion formed by cutting and bending so as to engage with the hole. The notch portion formed as the concave portion and the notch portion formed as the engaging portion are bent in the same direction. It thus becomes possible to form the concave portion and the engaging portion forming the rotation inhibiting portion (formed in the second step) at the same time.

These and other objects, features and advantages of the present invention will become more apparent upon reading of the following detailed description along with the accompanied drawings.

### BRIEF DESCRIPTION OF THE DRAWINGS

FIG. 1 is a cross section taken on line I-I of FIG. 6 as a view showing a first embodiment;

FIG. 2 is a view showing an assembled state of FIG. 1 before caulking;

FIG. 3 is a cross section taken on line III-III of FIG. 6;

FIG. 4 is a view showing an assembled state of FIG. 3 before caulking;

FIG. 5 is a perspective view of a punch and a die used for caulking;

FIG. 6 is a view showing a point at which a lift arm and an equalizer arm of one example are attached;

FIG. 7 is a view used to describe another example;

FIG. 8 is a view when FIG. 7 is viewed in a direction indicated by an arrow VIII;

FIG. 9 is a view showing a second embodiment;

FIG. 10 is a view showing a third embodiment;

FIG. 11 is a view used to describe an X-arm window regulator; and

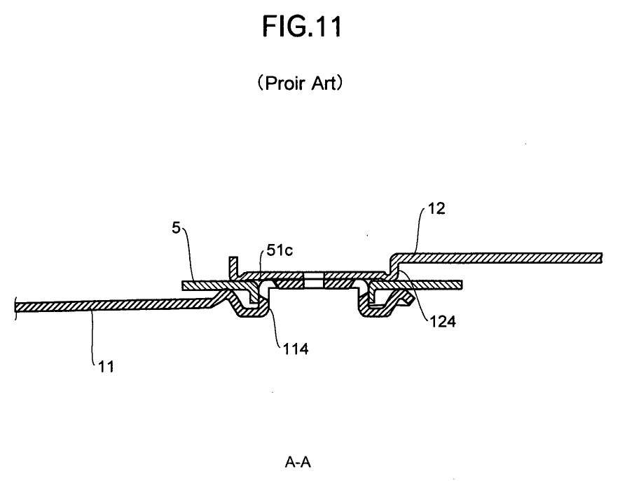

FIG. 12 is a cross section taken on line A-A of FIG. 11.

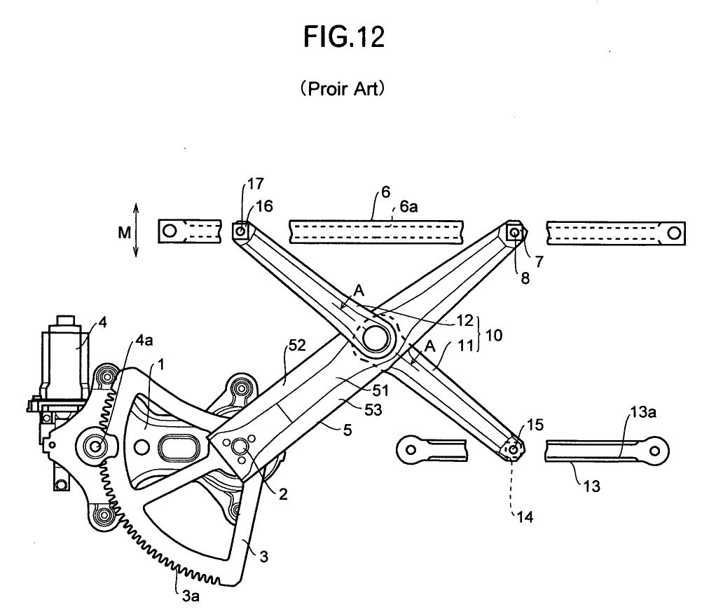

### DESCRIPTION OF THE PREFERRED EMBODIMENTS

### First Embodiment

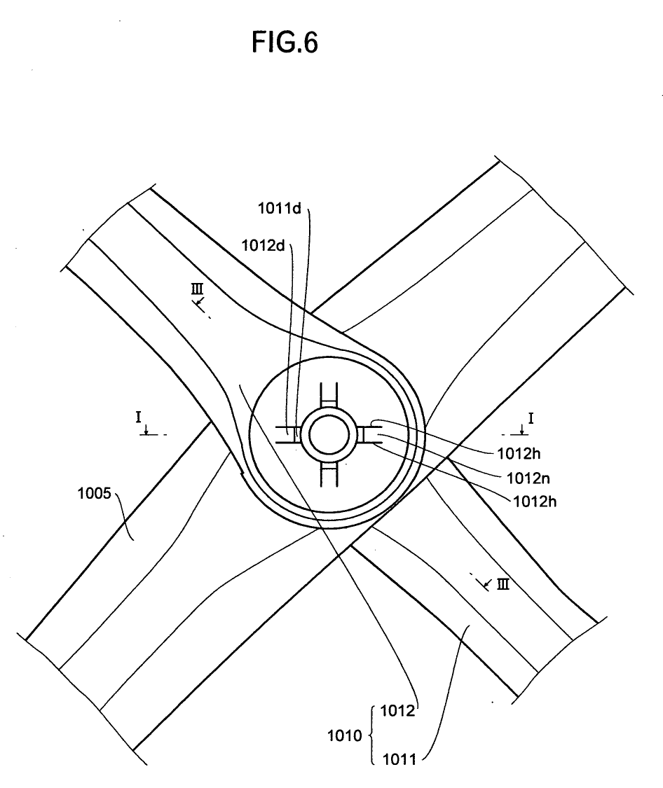

A difference between the configuration of a window regulator of this embodiment and the configuration of the window regulator described in the background art is the attachment of a lift arm and an equalizer arm. As is shown in FIG. 6, an equalizer arm 1010 of this embodiment is formed of a first arm portion 1011 and a second arm portion 1012 as with the configuration of the window regulator described in the background art.

The first arm portion 1011 and the second arm portion 1012 are attached to each other via a hole in a lift arm 1005. The intermediate portion of the equalizer arm 1010 is thus pivotally attached to the intermediate portion of the lift arm 1005 in a rotatable manner while crossing the lift arm 1005 in the shape of a letter X.

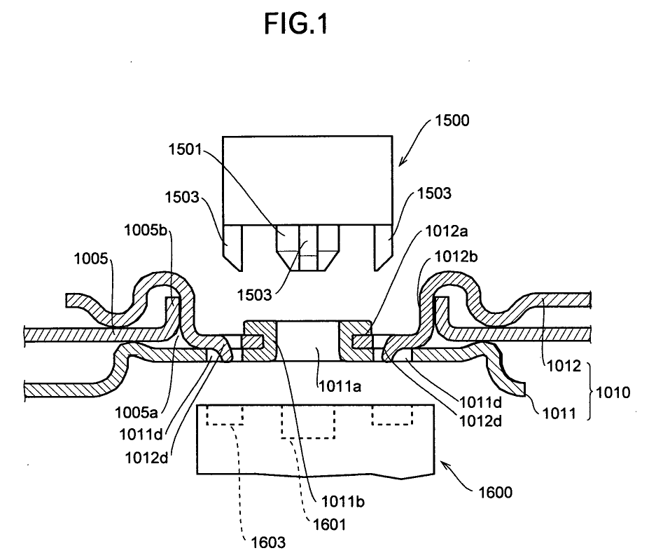

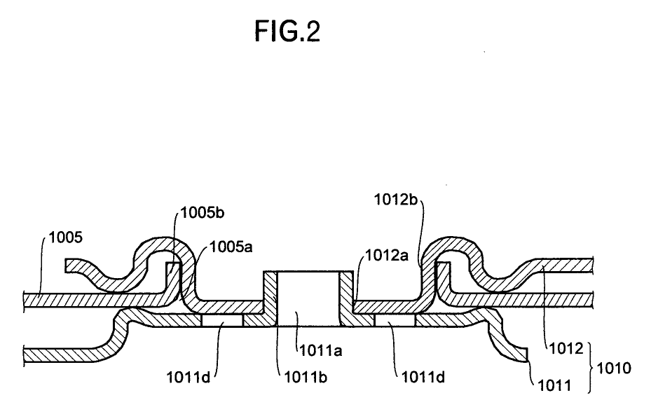

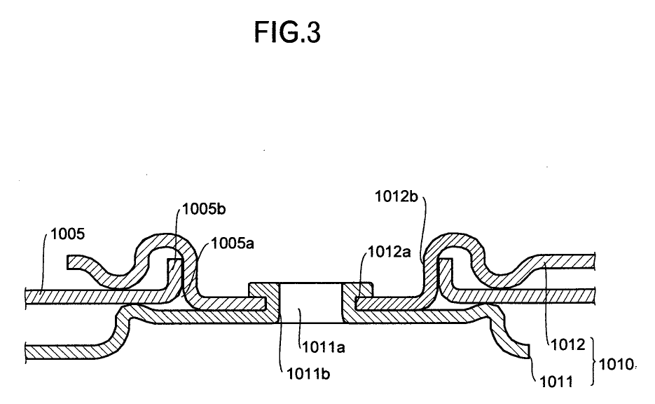

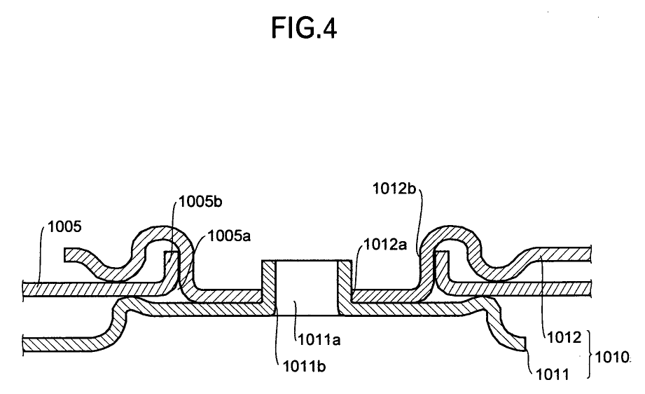

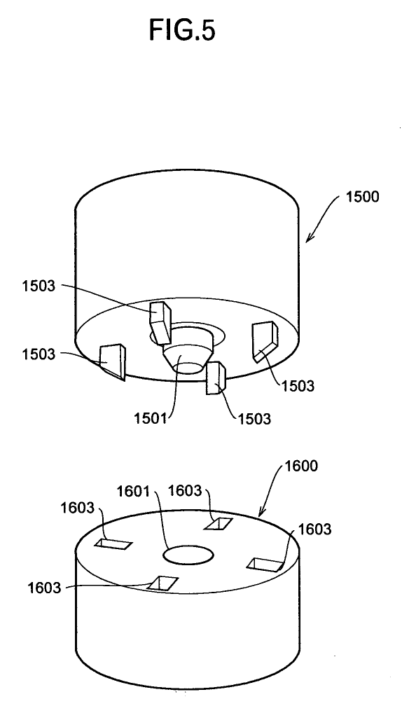

The attachment of the lift arm 1005 and the equalizer arm 1010 will now be described using FIG. 1 through FIG. 5. FIG. 1 is a cross section taken on line I-I of FIG. 6. FIG. 2 is a view showing an assembled state of FIG. 1 before caulking. FIG. 3 is a cross section taken on line III-III of FIG. 6. FIG. 4 is a view showing an assembled state of FIG. 3 before caulking. FIG. 5 is a perspective view of a punch and a die used for caulking.

As are shown in FIG. 1 through FIG. 4, a hole 1005a is formed to penetrate through the intermediate portion of the lift arm 1005 by means of burring, and a cylindrical rising wall portion 1005b extending in the direction of the second arm portion 1012 of the equalizer arm 1010 is formed along the peripheral surface of the hole 1005a.

A cylindrical concave portion 1012b to be fit inside the rising wall portion 1005b of the lift arm 1005 is formed in the second arm portion 1012 of the equalizer arm 1010 disposed above the lift arm 1005. A hole 1012a is formed to penetrate through the bottom surface of the concave portion 1012b.

A hole 1011a is formed by means of burring to penetrate through the first arm portion 1011 of the equalizer arm 1010 disposed below the lift arm 1005. Arising wall portion (convex portion) 1011b is formed along the peripheral surface of the hole 1011a. The rising wall portion 1011b is inserted through the hole 1012a of the second arm portion 1012 and protrudes to the outside from the hole 1012a of the second arm portion 1012.

Rectangular holes (concave portions) 1011d are formed to penetrate through the first arm portion 1011 around the rising wall portion 1011b at four points at a pitch of 90°.

An attaching method of the lift arm 1005 and the equalizer arm 1010 will now be described.

As are shown in FIG. 2 and FIG. 4, the second arm portion 1012 of the equalizer arm 1010 is disposed above the lift arm 1005 and the concave portion 1012b of the second arm portion 1012 is fit inside the rising wall portion 1005b of the lift arm 1005.

Also, the first arm portion 1011 of the equalizer arm 1010 is disposed below the lift arm 1005 and assembled in such a manner that the rising wall portion 1011b of the first arm portion 1011 protrudes to the outside from the hole 1012a of the second arm portion 1012.

Caulking is then applied using an upper punch 1500 and a die 1600 as are shown in FIG. 1 and FIG. 5. The punch 1500 is provided with a rising wall caulking portion 1501 in the shape of a cylindrical column having a truncated conical tip end at the center portion on the face opposing the die 1600. The punch 1500 is also provided with notching and caulking portions 1503 in the shape of an obliquely truncated prism opposing the four holes 1011d (concave portions) formed in the first arm portion 1011 around the rising wall portion 1011b on the face opposing the die 1600.

When the truncated conical portion of the rising wall caulking portion 1501 is inserted into the hole 1011a of the first arm portion 1011, caulking is applied in such manner so as to widen the diameter of the rising wall portion 1011b at the tip end. Also, each notching and caulking portion 1503 cuts a notch in the second arm portion 1012, and applies caulking in such a manner that the notched portion is bent in the direction of the first arm portion 1011. The die 1600 is provided with a hole 1601 large enough for inserting the rising wall caulking portion 1501 and four holes 1603 large enough for inserting the notching and caulking portions 1503 on the face opposing the upper punch 1500.

With the use of the upper punch 1500 and the die 1600 as above, as are shown by the flow from FIG. 2 to FIG. 1 and the flow from FIG. 4 to FIG. 3, a part of the rising wall portion 1011b of the equalizer arm 1010 protruding to the outside from the hole 1012a of the second arm portion 1012 is caulked to come into contact with the rim of the hole 1012a of the second arm portion 1012 by the rising wall caulking portion 1501 of the punch 1500. Separation of the first arm portion 1011 and the second arm portion 1012 is thus inhibited.

Further, as is shown by the flow from FIG. 2 to FIG. 1, each notch portion 1012d (engaging portion) formed by cutting and bending the second arm portion 1012 is caulked so as to engage with the corresponding hole 1011d of the first arm portion 1011 by the corresponding notching and caulking portion 1503 of the punch 1500. Relative rotations of the first arm portion 1011 and the second arm portion 1012 are thus inhibited.

In this embodiment, as is shown in FIG. 6, each of the notch portions 1012d of the second arm portion 1012 caulked by the corresponding notching and caulking portions 1503 has radial notch edges 1012h in a direction substantially along the radial direction of the rotational center axis of the lift arm 1005 and the equalizer arm 1010 and a root portion 1012n crossing the radial direction of the rotational center axis of the lift arm 1005 and the equalizer arm 1010 and connected to the second arm portion 1012. Herein, the root portion 1012n is defined as a shape present at an end of the radial notch edges 1012h on the opposite side of the rotational center axis of the lift arm 1005 and the equalizer arm 1010.

Accordingly, the rising wall portion (convex portion) 1011b of the first arm portion 1011 whose tip end is caulked and the hole 1012a of the second arm portion 1012 together form a separation inhibiting portion that inhibits separation of the first arm portion 1011 and the second arm portion 1012.

Also, the holes (concave portions) 1011d formed in the first arm portion 1011 and the notch portions 1012d formed by cutting and bending the second arm portion 1012 so as to engage with the holes 1011d together form a rotation inhibiting portion that inhibits relative rotations of the first arm portion 1011 and the second arm portion 1012.

According to the window regulator and the attaching method of the lift arm and the equalizer arm of the window regulator as above, advantages as follows can be obtained.

(1) The caulked portions, that is, the tip end of the rising wall portion 1011b of the first arm portion 1011 and the notch portions 1012d of the second arm portion 1012, are exposed to the outside. It is therefore possible to visually confirm the quality of attachment of the first arm portion and the second arm portion.

(2) The caulking direction of the rising wall portion 1011b forming the separation inhibiting portion and the forming direction of the notch portions 1012d forming the rotation inhibiting portion are in the same direction. Caulking can be therefore applied by a set of the upper punch 1500 and the die 1600, and attachment of the lift arm 1005 and the equalizer arm 1010 can be completed in a single step.

It should be appreciated that the invention is not limited to the embodiment above. For example, in the embodiment above, the four holes and the notch portions forming the rotation inhibiting portion are formed in the first arm portion 1011 and the second arm portion 1012, respectively. However, it may be configured inversely in such a manner that the four holes and the notch portions forming the rotation inhibiting portion are formed in the second arm portion 1012 and the first arm portion 1011, respectively.

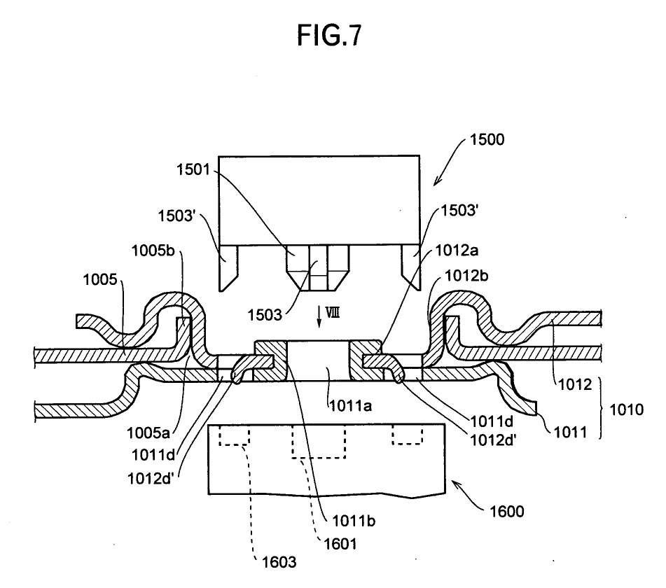

Further, in the embodiment above, the root portion 1012n of each notch portion 1012d of the second arm portion 1012 formed by the corresponding notching and caulking portion 1503 is defined as the shape present at an end of the radial notch edges 1012h on the opposite side of the rotational center axis of the lift arm 1005 and the equalizer arm 1010. However, like a notch portion 1012d′ shown in FIG. 7, it may be defined as a shape present at an end of the radial notch edges 1012h on the side of the rotational center axis of the lift arm 1005 and the equalizer arm 1010.

In this case, when a force such that induces relative rotations of the first arm portion 1011 and the second arm portion 1012 is applied, relative rotations of the first arm portion 1011 and the second arm portion 1012 can be regulated more strictly because the abutting portions of the notch portions 1012d′ and the corresponding holes 1011d are at positions farther from the center of the relative rotations of the first arm portion 1011 and the second arm portion 1012.

Also, a loading direction when the notch portions 1012d′ are caulked is a direction in which the concave portion 1012b of the second arm portion 1012 of the equalizer arm 1010 moves away from the rising wall portion 1005b, which is the peripheral surface of the hole 1005a of the lift arm 1005, and it is also a direction in which the rising wall portion (convex portion) 1011b of the first arm portion 1011 and the peripheral surface of the hole 1012a of the second arm portion 1012 of the equalizer arm 1010 come close to each other. Rotations of the lift arm 1005 and the equalizer arm 1010 can be thus maintained smoothly.

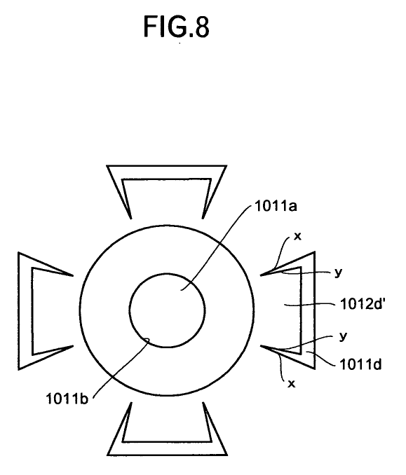

Further, it is preferable that the holes 1011d and the notch portions 1012d′ are formed in the shapes as are shown in FIG. 8, which is a view when FIG. 7 is viewed in the direction indicated by an arrow VIII. The holes 1011d are formed at four points at the pitch of 90° in the circumferential direction about the rotational center axis of the lift arm 1005 and the equalizer arm 1010. Each hole 1011d is of a trapezoidal (rectangular) shape in which the interval between the two sides substantially along the radial direction of the rotational center axis of the lift arm 1005 and the equalizer arm 1010 increases gradually from the rotational center axis toward the radial direction.

Each notch portion 1012d′ is of a trapezoidal (rectangular) portion in which the interval between the two sides substantially along the radial direction of the rotational center axis of the lift arm 1005 and the equalizer arm 1010 increases gradually from the rotational center axis toward the radial direction, and it is cut and bent so as to engage with the corresponding trapezoidal holes 1011d.

According to the configuration above, relative rotations of the first arm portion 1011 and the second arm portion 1012 can be inhibited. Meanwhile, when an attempt is made to separate the first arm portion 1011 and the second arm portion 1012, the two sides y and y of each notch portion 1012d′ substantially along the radial direction of the rotational center axis of the lift arm 1005 and the equalizer arm 1010 hit on the two sides x and x of the corresponding hole 1011d substantially along the radial direction of the rotational center axis of the lift arm 1005 and the equalizer arm 1010. Any further separation can be thus inhibited.

### Second Embodiment

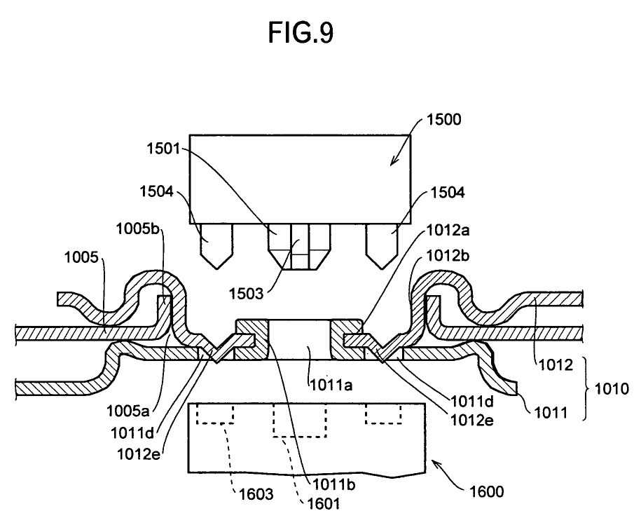

In the first embodiment above, the notch portions 1012d to be engaged with the holes 1011d of the first arm portion 1011 are formed by cutting and bending the second arm portion 1012 using the notching and caulking portions 1503 of the upper punch 1500. In a second embodiment, as is shown in FIG. 9, convex portions 1012e pushed out so as to engage with the corresponding holes 1011d of the first arm portion 1011 are formed in the second arm portion 1012 using concave forming portions 1504 of the upper punch 1500.

### Third Embodiment

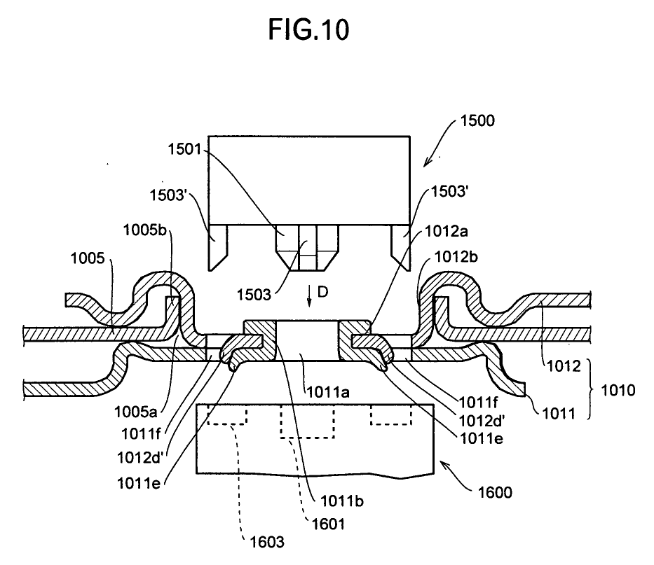

In the first embodiment above, the concave portions of the first arm portion 1011 are the through-holes 1011d of a rectangular shape provided around the rising wall portion 1011b at four points at a pitch of 90°. In this embodiment, as is shown in FIG. 10, holes 1011f are developed when notch portions 1011e are formed by cutting and bending the first arm portion 1011, and notch portions 1012d′ formed by cutting and bending the second arm portion 1012 in the same direction as the notch portions 1011e are engaged with the corresponding holes 1011f.

According to the configuration as above, the notch portions 1011e as the concave portions and the notch portions 1012d′ as the engaging portions are bent in the same direction. It thus becomes possible to form the concave portions and the engaging portions forming the rotation inhibiting portion at the same time. This eliminates the need to form holes in the first arm portion 1011 in advance.

Although the present invention has been fully described by way of example with reference to the accompanying drawins, it is to be understood that various changes and modifications will be apparent to those skilled in the art. Therefore, unless otherwise such changes and modification depart from the scope of the present invention hereinafter defined, they should be construed as being included therein.

What is claimed is:

1. A window regulator, comprising:
a lift arm having a hole formed to penetrate through an intermediate portion and provided in a rotatable manner;
a lift arm bracket attached to a windowpane and provided with a guide extending in a direction crossing an opening and closing direction of the windowpane and configured to engage with a tip end portion of the lift arm by the guide;
an equalizer arm formed of a first arm portion and a second arm portion, an intermediate portion of which is pivotally attached to the intermediate portion of the lift arm in a rotatable manner while crossing the lift arm in a shape of a letter X and a tip end portion of which engages with the lift arm bracket when the first arm portion and the second arm portion are attached to each other via the hole of the lift arm; and
an equalizer arm bracket provided with a guide parallel to the guide of the lift arm bracket and configured to guide a base end portion of the equalizer arm by the guide, wherein:
the windowpane is opened and closed by rotating the lift arm;
separation of the first arm portion and the second arm portion is inhibited by a separation inhibiting portion formed of a hole formed to penetrate through the second arm portion and a convex portion formed in the first arm portion, a part of which protruding to an outside from the hole of the second arm portion when inserted into the hole of the lift arm and the hole of the second arm portion is caulked so as to come into contact with a rim of the hole of the second arm portion; and
a relative rotation of the first arm portion and the second arm portion is inhibited by a rotation inhibiting portion formed of a concave portion formed in one of the first arm portion and the second arm portion and an engaging portion formed in the other arm portion to engage with the concave portion.

2. The window regulator according to claim 1, wherein:
the engaging portion forming the rotation inhibiting portion is a notch portion that is cut and bent so as to engage with the concave portion.

3. The window regulator according to claim 1, wherein:
the engaging portion forming the rotation inhibiting portion is a convex portion that is pushed out so as to engage with the concave portion.

4. The window regulator according to claim 1, wherein:
a caulking direction of the convex portion forming the separation inhibiting portion and a forming direction of the engaging portion forming the rotation inhibiting portion are in a same direction.

5. The window regulator according to claim 2, wherein:
the notch portion forming the rotation inhibiting portion has a radial notch edge in a direction substantially along a radial direction of a rotational center axis of the lift arm and the equalizer arm and a root portion crossing the radial direction of the rotational center axis of the lift arm and the equalizer arm and connected to the other arm portion; and
the root portion is present at an end of the radial notch edge on a side of the rotational center axis of the lift arm and the equalizer arm.

6. The window regulator according to claim 1, wherein:
the concave portion forming the rotation inhibiting portion is a rectangular hole in which an interval between two sides substantially along a radial direction of a rotational center axis of the lift arm and the equalizer arm increases gradually from the rotational center axis toward the radial direction; and
the engaging portion forming the rotation inhibiting portion is a notch portion cut and bent so as to engage with the rectangular hole, which is of a rectangular shape in which an interval between two sides substantially along the radial direction of the rotational center axis of the lift arm and the equalizer arm increases gradually from the rotational center axis toward the radial direction.

7. The window regulator according to claim 1, wherein:
the concave portion forming the rotation inhibiting portion is a hole developed when the notch portion is formed by cutting and bending;
the engaging portion forming the rotation inhibiting portion is a notch portion formed by cutting and bending so as to engage with the hole; and
the notch portion formed as the concave portion and the notch portion formed as the engaging portion are bent in a same direction.

8. An attaching method of a lift arm and an equalizer arm of a window regulator that is formed of:
a lift arm having a hole formed to penetrate through an intermediate portion and provided in a rotatable manner;
a lift arm bracket attached to a windowpane and provided with a guide extending in a direction crossing an opening and closing direction of the windowpane and configured to engage with a tip end portion of the lift arm by the guide;
an equalizer arm formed of a first arm portion and a second arm portion, an intermediate portion of which is pivotally attached to the intermediate portion of the lift arm in a rotatable manner while crossing the lift arm in a shape of a letter X and a tip end portion of which engages with the lift arm bracket when the first arm portion and the second arm portion are attached to each other via the hole of the lift arm; and
an equalizer arm bracket provided with a guide parallel to the guide of the lift arm bracket and configured to guide a base end portion of the equalizer arm by the guide, and configured to open and close the windowpane by rotating the lift arm,
the attaching method comprising:
a first step of forming a hole to penetrate through the second arm portion and forming a convex portion in the first arm portion so that a part of the convex portion of the first arm portion protruding to an outside from the hole of the second arm portion when inserted into the hole of the lift arm and the hole of the second arm is caulked so as to come into contact with a rim of the hole of the second arm portion; and
a second step of forming a concave portion to one of the first arm portion and the second arm portion and forming an engaging portion to engage with the concave portion to the other arm portion.

9. The attaching method of a lift arm and an equalizer arm of a window regulator according to claim 8, wherein:
the engaging portion formed in the second step is a notch portion that is cut and bent so as to engage with the concave portion.

10. The attaching method of a lift arm and an equalizer arm of a window regulator according to claim 8, wherein:
the engaging portion formed in the second step is a convex portion that is pushed out so as to engage with the concave portion.

11. The attaching method of a lift arm and an equalizer arm of a window regulator according to claim 8, wherein:
a caulking direction in the first step portion and a forming direction of the engaging portion in the second step are in a same direction.

12. The attaching method of a lift arm and an equalizer arm of a window regulator according to claim 9, wherein:
the notch portion formed in the second step has a radial notch edge in a direction substantially along a radial direction of a rotational center axis of the lift arm and the equalizer arm and a root portion crossing the radial direction of the rotational center axis of the lift arm and the equalizer arm and connected to the other arm portion; and
the root portion is present at an end of the radial notch edge on a side of the rotational center axis of the lift arm and the equalizer arm.

13. The attaching method of a lift arm and an equalizer arm of a window regulator according to claim 8, wherein:
the concave portion formed in the second step is a rectangular hole in which an interval between two sides substantially along a radial direction of a rotational center axis of the lift arm and the equalizer arm increases gradually from the rotational center axis toward the radial direction; and
the engaging portion formed in the second step is a notch portion cut and bent so as to engage with the rectangular hole, which is of a rectangular shape in which an interval between two sides substantially along the radial direction of the rotational center axis of the lift arm and the equalizer arm increases gradually from the rotational center axis toward the radial direction.

14. The attaching method of a lift arm and an equalizer arm of a window regulator according to claim 8, wherein:
the concave portion formed in the second step is a hole developed when the notch portion is formed by cutting and bending;
the engaging portion formed in the second step is a notch portion formed by cutting and bending so as to engage with the hole; and
the notch portion formed as the concave portion and the notch portion formed as the engaging portion are bent in a same direction.
